(19) United States
(12) Patent Application Publication
(10) Pub. No.: US 2023/0339713 A1
(43) Pub. Date: Oct. 26, 2023

(54) Sensor Configuration to Indicate Available Media of a Printer

(71) Applicant: ZEBRA TECHNOLOGIES CORPORATION, Lincolnshire, IL (US)

(72) Inventors: Suwei Wang, Guangzhou (CN); Yong Liu, Guangzhou (CN); Bo Liu, Guangzhou (CN); Zhong Gui Wang, Guangzhou (CN)

(21) Appl. No.: 17/920,485

(22) PCT Filed: Oct. 26, 2021
(86) PCT No.: PCT/CN2021/126494

§ 371 Date: May 23, 2023

(51) Int. Cl. B65H 16/02

(52) U.S. Cl. CPC B65H 16/02; B65H 2801/75; B65H 2301/41522; B65H 2553/416

(57) ABSTRACT

A system to monitor available media in a printer is disclosed. The system may include a media holder that includes a support frame and a support member that extends from the support frame. The support member may be configured to receive a media roll. The system may include an optical sensor attached to the support frame of the media holder. The optical sensor may be configured to include an axial end of the media roll within a field of view of the optical sensor. The optical sensor may be configured to output sensor data that indicates whether the media roll has available media according to a radius of the axial end.

### TECHNICAL FIELD

The present disclosure relates generally to printer media and, for example, to a sensor configuration to indicate available media of a printer.

### BACKGROUND

A printer may receive and store (e.g., in a tray and/or on a roll) media (e.g., paper or other similar type of material). Over time, as the printer prints content to the media, the media is consumed and output for use. Accordingly, there is a need for the printer to indicate a quantity of the media that has been consumed (or that remains) to permit a user to replace the consumed media with new media.

### BRIEF DESCRIPTION OF THE DRAWINGS

FIG. 1 is a diagram of an example implementation associated with a printer described herein.

FIG. 2 is a diagram of an example implementation associated with a sensor and a media holder of a printer described herein.

FIG. 3 is a diagram of an example implementation associated with a configuration of a sensor of a printer described herein.

FIG. 4 is a diagram of an example implementation associated with a configuration of sensors of a printer described herein.

FIG. 5 is a diagram of an example implementation associated with a sensor configuration for a printer described herein.

FIG. 6 is a diagram of an example environment in which systems and/or methods described herein may be implemented.

FIG. 7 is a diagram of example components of one or more devices of FIG. 6.

FIG. 8 is a flowchart of an example process associated with indicating available media in a printer.

### DETAILED DESCRIPTION

The following detailed description of example implementations refers to the accompanying drawings. The same reference numbers in different drawings may identify the same or similar elements.

A printer is typically configured to store a maximum quantity of media. For example, a printer (e.g., a label printer) may print content onto media of a media roll that can have a maximum radius due to a physical design and configuration of one or more of the printer, the media roll, or a support member of the printer that holds the media roll. If the printer receives a printing instruction for a printing operation that requires a greater quantity of media (e.g., length of media on the media roll) than is remaining on the media roll, the printing operation may be interrupted and/or may not be completed. An indicator that indicates a remaining quantity of media stored in the printer may enable a user or a system providing print instructions to the printer to determine whether the printer is storing a sufficient quantity of media for a print operation. Accordingly, there is a need to indicate whether a printer has available media on a media roll.

However, different types of media rolls may include different quantities of labels (e.g., due to the labels having different lengths). Furthermore, for a media roll that enables the printer to print labels of various lengths (e.g., a media roll that enables printed labels to be torn from the media roll), different printing operations may require different quantities (or lengths) of the media roll to complete the printing operations (e.g., due to different amounts of content in the printing operations requiring the different quantities of the media roll). Accordingly, there is a need to determine and/or indicate whether a printer has available media on a media roll and/or a remaining quantity of the available media on the media roll.

Some implementations described herein provide a system of a printer that is configured to determine and/or indicate available media of the printer. For example, the system (and/or printer) may include a sensor configuration that is configured to sense, measure, and/or indicate a remaining quantity of media on a media roll based on a radius of the media roll. The sensor configuration may include one or more optical sensors and/or an image sensor (e.g., a camera) that are configured to provide sensor data that is indicative of the radius of the media roll.

In this way, the system, as described herein, may determine available media of a printer regardless of a type of media on a media roll and/or lengths of individual labels on the media roll. Accordingly, the system and/or the printer may be interoperable with various types of media rolls and/or media rolls with labels of different lengths. Furthermore, the system and/or the printer may avoid wasting or consuming computing resources (e.g., processor resources and/or memory resources) associated with interrupted printing operations caused by a printer initiating or performing a printing operation that requires more media than is available or remaining on a media roll. Moreover, the system may reduce wasting media that is consumed by a printing operation that results in the wasted media being an incomplete label (e.g., because the remaining quantity on the media roll was insufficient to receive the content of the printing operation for a complete label).

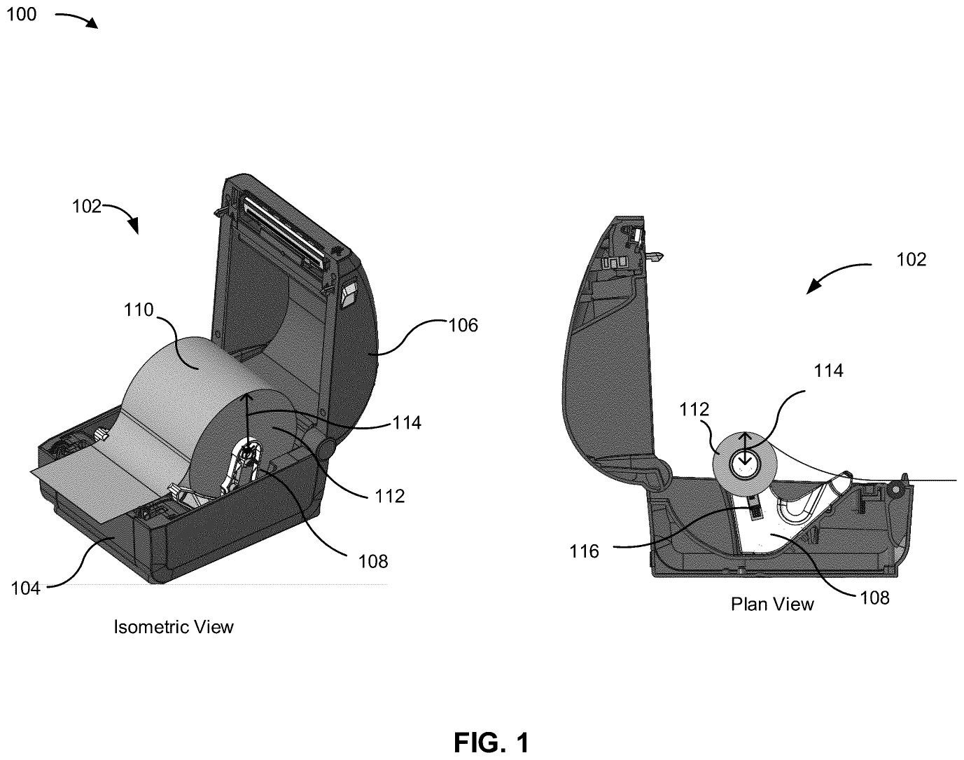

FIG. 1 is a diagram of an example implementation 100 associated with a printer 102 described herein. FIG. 1 includes an isometric view and a plan view of the printer 102. The printer 102 includes a base 104 and a lid 106 that is attached to the base. The lid 106 may be opened to enable access (e.g., by a user) to a media holder 108 in the base 104 of the printer 102.

In example implementation 100, the media holder 108 is configured to store and/or hold a media roll 110. The media roll 110 has an axial end 112 with a radius 114. The media holder 108 may be removable from the base 104 of the printer 102 (e.g., to facilitate replacement of the media roll 110 and/or maintenance of the printer 102). During operation, as the printer 102 prints content onto portions of the media roll 110, the radius 114 of the axial end 112 decreases as the portions are output from the printer 102 (e.g., to provide printed labels). For example, the plan view shows an image of the media roll 110 after the printer 102, as shown in the isometric view, has performed one or more printing operations. In such a case, as shown, the radius 114 in the plan view is smaller than the radius 114 in the isometric view.

The printer 102 may include an optical sensor 116 (as shown in the plan view). The optical sensor 116 may be configured, arranged, and/or positioned in a manner such that the axial end 112 (e.g., at least a portion of the axial end 112) is within a field of view of the optical sensor 116. In some implementations, the optical sensor 116 may be attached to the media holder 108. The optical sensor 116 may be configured to output sensor data that indicates whether the media roll has available media according to the radius of the axial end of the media roll. For example, optical sensor 116 may be configured to indicate sensor data that is indicative of the radius 114 of the media roll. In some implementations, as described elsewhere herein, the optical sensor 116 may be configured to provide sensor data that is indicative of whether the radius 114 satisfies one or more thresholds associated with certain remaining quantities of media on the media roll 110.

The printer 102, as described elsewhere herein, may include a user interface (e.g., an output component such as one or more light emitting diodes (LEDs) and/or a display) that is configured to output an indication of the available media (or remaining quantity of the media roll) of the printer 102 according to the sensor data from the optical sensor 116.

In this way, the printer 102 may include a system and/or a sensor configuration that is arranged to indicate available media on a media roll.

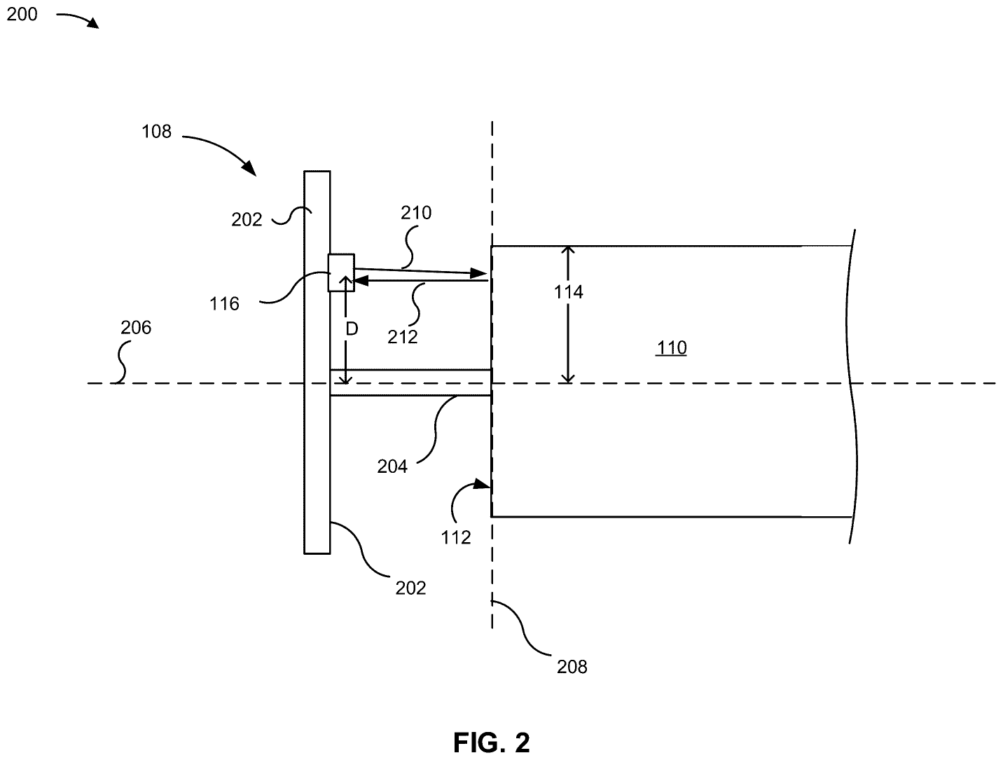

FIG. 2 is a diagram of an example implementation 200 associated with the optical sensor 116 and the media holder 108 of the printer 102. As shown in FIG. 2, the media holder 108 may include a support frame 202 and a support member 204. The support member 204 may extend from the support frame 202 along a support axis 206 that is perpendicular to the support frame 202. For example, during operation of the printer 102, the support frame 202 may be configured to be vertical within the base 104 of the printer 102 and the support member 204 may be configured to extend horizontally across the printer 102. Although a single end of the support member 204 is shown as being attached to the support frame 202 of the media holder 108, in some implementations, both ends of the support member may be attached to the support frame 202 (or another portion of the support frame 202).

In example implementation 200, the optical sensor 116 is attached to the support frame 202 and the support member 204 may have received the media roll 110. The optical sensor 116 may be positioned on the support frame 202 at a distance D from the support axis 206. The optical sensor 116 may be positioned to have a field of view that is directed toward (e.g., according to an angular direction of the field of view) a plane 208 of the axial end 112 of the media roll 110. For example, based on being attached to the support frame 202 and/or having directional optical sensing elements (e.g., sensing elements that are configured to detect or sense reflected light from a particular direction or angle), the optical sensor 116 be configured to sense or detect one or more characteristics of the axial end 112 of the media roll 110. As shown, the media holder 108, may be arranged and/or configured such that the plane 208 of the axial end 112 is perpendicular to the support axis 206.

In some implementations, the sensor data from the optical sensor 116 may be a binary indication of whether the media roll 110 has available media at a radial distance along the radius 114 of the axial end 112. The radial distance may correspond (or be equivalent) to the distance D. For example, the optical sensor 116 of example implementation 200 may have a field of view that corresponds to a line of sight that is parallel to the support axis 206. More specifically, the optical sensor 116 may include a reflective sensor that is configured to emit light 210 (e.g., a beam of light, such as a laser) via a light emitter, toward the axial end 112 of the media roll 110. If the optical sensor 116 detects a reflection 212 of the light, the optical sensor 116 may generate sensor data associated with a remaining quantity of the media roll 110 satisfying a threshold that is based on the distance between the line of sight of the optical sensor 116 and the support axis of the support member. The threshold may be associated with a low available media indication. Accordingly, if the radius 114 is less than the distance D, then the optical sensor 116 would not detect reflected light from the axial end 112, and the optical sensor 116 may indicate that the remaining quantity of the media roll 110 does not satisfy the threshold. In such a case, the printer 102 may output, via a user interface, an indication that the media roll has a low remaining quantity of media.

In this way, the sensor data from the optical sensor 116 may include a binary indication of whether the media roll 110 has available media at a radial distance along the radius 114 that is based on the distance D between the optical sensor 116 and the support member 204 (or support axis 206).

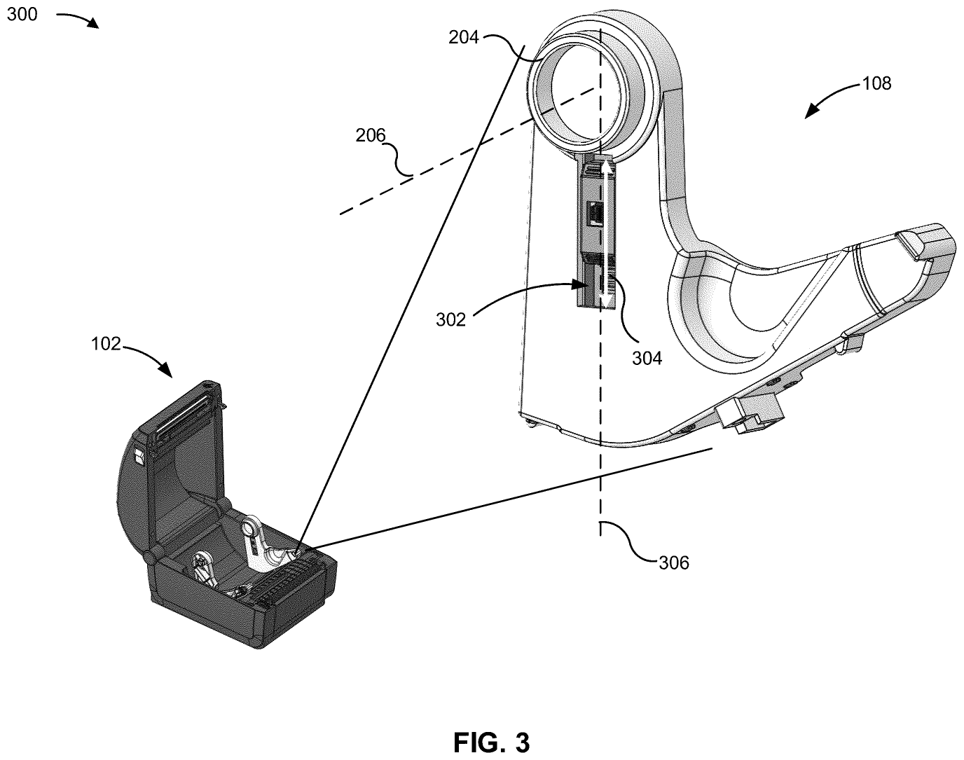

FIG. 3 is a diagram of an example implementation 300 associated with a configuration of the optical sensor 116 of the printer 102. As shown in FIG. 3, the optical sensor 116 may be configured to be received within and/or positioned within a track 302 of the media holder 108. For example, the optical sensor may be attached to the support frame via a housing of the optical sensor 116 that is slidable within the track 302.

The track 302 may have a path 304 with a longitudinal axis 306 that is perpendicular to the support axis 206 of the support frame 202. The track 302 may permit the optical sensor 116 to slide along the path 304 (and/or along the longitudinal axis 306 of the path 304) in order to permit a threshold for indicating a remaining quantity of available media to be adjustable. For example, if the optical sensor 116 is adjusted (e.g., slid) or positioned within the track 302 to be nearer the support axis 206, a threshold for indicating a low remaining quantity of available media may be lower than if the optical sensor 116 is slid further from the support axis 206.

In this way, the optical sensor 116 may provide sensor data that indicates a remaining quantity of the media roll based on a position of the optical sensor along the path 304.

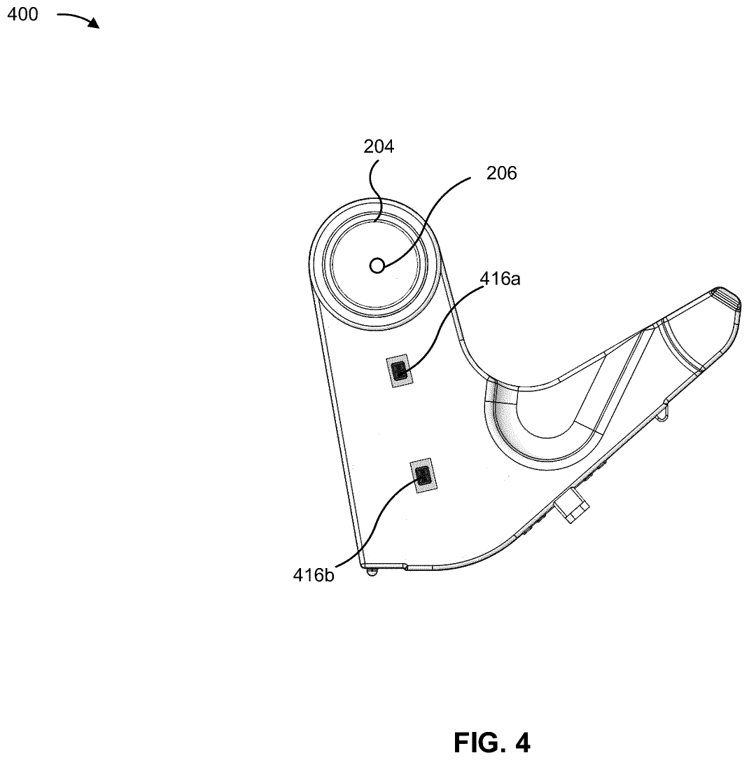

FIG. 4 is a diagram of an example implementation 400 associated with a configuration of sensors of a printer (e.g., the printer 102).

In example implementation 400, a first optical sensor 416a and second optical sensor 416b are attached to the media holder 108. The distance (e.g., a first distance) between the first optical sensor 416a and the support member 204 (or support axis) may be different from the distance (e.g., a second distance) between the second optical sensor 416b and the support member 204. For example, the first optical sensor 416a is positioned nearer to the support member and/or the support axis 206 than the second optical sensor 416b.

The first optical sensor 416a and the second optical sensor 416b may correspond to the optical sensor 116 described above. Accordingly, the first optical sensor 416a may have a line of sight (e.g., a first line of sight) that is parallel to a line of sight (e.g., a second line of sight) of the second optical sensor 416b. Furthermore, the line of sight of the first optical sensor 416a and the line of sight of the second optical sensor 416b may both be parallel to the support axis 206. In this way, similar to the optical sensor 116, the first optical sensor 416a may be configured to indicate a remaining quantity of available media on a media roll based on the distance between the first optical sensor 416a and the support member 204, and the second optical sensor 416b may be configured to indicate a remaining quantity of available media on a media roll based on the distance between the second optical sensor 416b and the support member 204. More specifically, the printer may determine whether a remaining quantity of available media is within one or more preconfigured sets of ranges based on sensor data from the first optical sensor 416a and the second optical sensor 416b. For example, if the sensor data indicates that both the first optical sensor 416a and the second optical sensor 416b detect the media roll, then the printer may indicate (or a controller of the printer) via a user interface that the remaining quantity is at a high level. If the sensor data indicates that the first optical sensor 416a detects the media roll and the second optical sensor 416b does not detect the media roll, then the printer may indicate that the remaining quantity is at a medium level. Finally, if the sensor data indicates that neither the first optical sensor 416a or the second optical sensor 416b detects the media roll, then the printer may indicate that the remaining quantity is at a low level.

In this way, a sensor configuration of multiple sensors may be used to indicate a remaining quantity of available media of a printer.

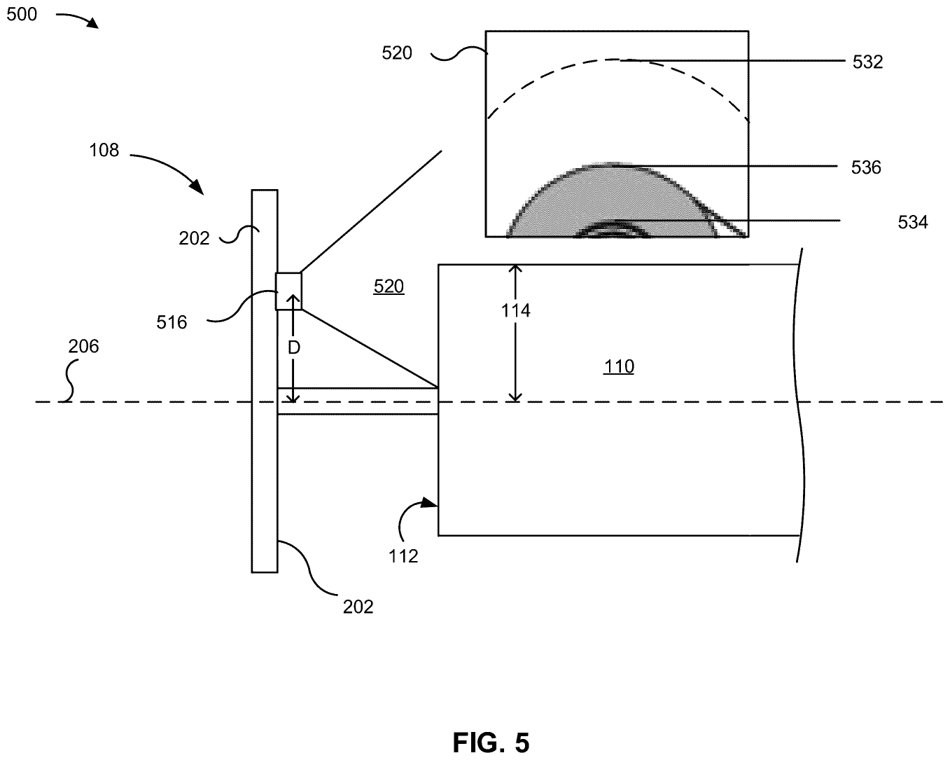

FIG. 5 is a diagram of an example implementation 500 associated with a sensor configuration for the printer 102. In example implementation 500, the printer 102 may include an image sensor 516 (e.g., a camera or other type of image sensor). For example, the image sensor 516 may be attached to the support frame 202 (e.g., similar to the optical sensor 116). As shown in FIG. 5, the image sensor 516 may be configured to capture an image 520 of the axial end 112 of the media roll 110. In some implementations, to brighten the interior of the printer 102 when capturing the image 520, the image sensor 516 may utilize a flash or other type of light emitter. The image sensor 516 may capture and/or preprocess image data of the image 520 using any suitable technique (e.g., to enhance features captured within the image) to enable the printer (or a controller of the printer 102) to analyze the image 520 (or a proprocessed version of the image 520), as described herein.

The image sensor 516 may capture the image based on the printer 102 performing a print operation. Additionally, or alternatively, the image sensor 516 may capture the image based on the media roll 110 being installed within the printer 102 (e.g., as determined or detected by a controller of the printer 102).

The printer 102 may include a controller that is configured to process images (e.g., using any suitable image processing technique, such as object detection, edge detection, or the like) from the image sensor 516 in order to determine a remaining quantity of available media. For example, the controller may determine individual radiuses of the axial end of the media roll as depicted within the image and determine a remaining quantity of available media on the media roll 110 based on the individual radius. For example, a first image (e.g., an image captured based on the media roll 110 being installed within the printer 102) may indicate that the media roll has a maximum radius 532 and a minimum radius 534. Furthermore, a second image (e.g., an image captured after one or more print operations were performed using media from the media roll 110) may be captured that indicates a current radius 536 of the media roll. Based on the maximum radius 532, the minimum radius 534, and the current radius 536, the printer 102 (e.g., via the controller) may determine a remaining quantity of available media on the media roll 110. More specifically, the printer 102 may determine the remaining quantity as a percentage of the maximum radius 532 based on one or more ratios and/or differences between the maximum radius 532, the minimum radius 534, and the current radius 536.

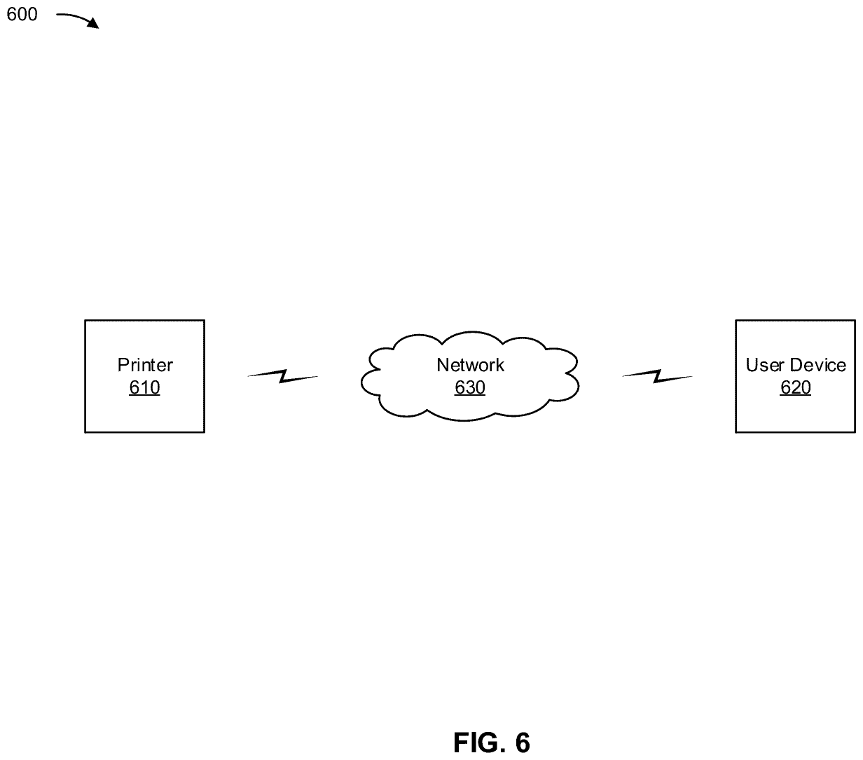

FIG. 6 is a diagram of an example environment 600 in which systems and/or methods described herein may be implemented. As shown in FIG. 6, the environment 600 may include a printer 610, a user device 620, and a network 630. Devices of environment 600 may interconnect via wired connections, wireless connections, or a combination of wired and wireless connections.

The printer 610 may include one or more devices capable of receiving, generating, processing, and/or providing information associated with an indication of a remaining quantity of available media, as described herein. The printer 610 may be configured to store a media roll and/or print content to media of the media roll according to a printing instruction received from the user device 620. The printer 610 may correspond to one or more of the printers described above.

The user device 620 includes one or more devices capable of receiving, generating, storing, processing, and/or providing information associated with a remaining quantity of available media of the printer 610, as described elsewhere herein. The user device 620 may be configured to provide a printing instruction to the printer 610 to cause the printer 610 to perform a printing operation, as described herein. The user device 620 may include a communication device and/or a computing device. For example, the user device 620 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The network 630 includes one or more wired and/or wireless networks. For example, the network 630 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 630 enables communication among the devices of environment 400.

The number and arrangement of devices and networks shown in FIG. 6 are provided as an example. In practice, there may be additional devices and/or networks, fewer devices and/or networks, different devices and/or networks, or differently arranged devices and/or networks than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) of environment 600 may perform one or more functions described as being performed by another set of devices of environment 600.

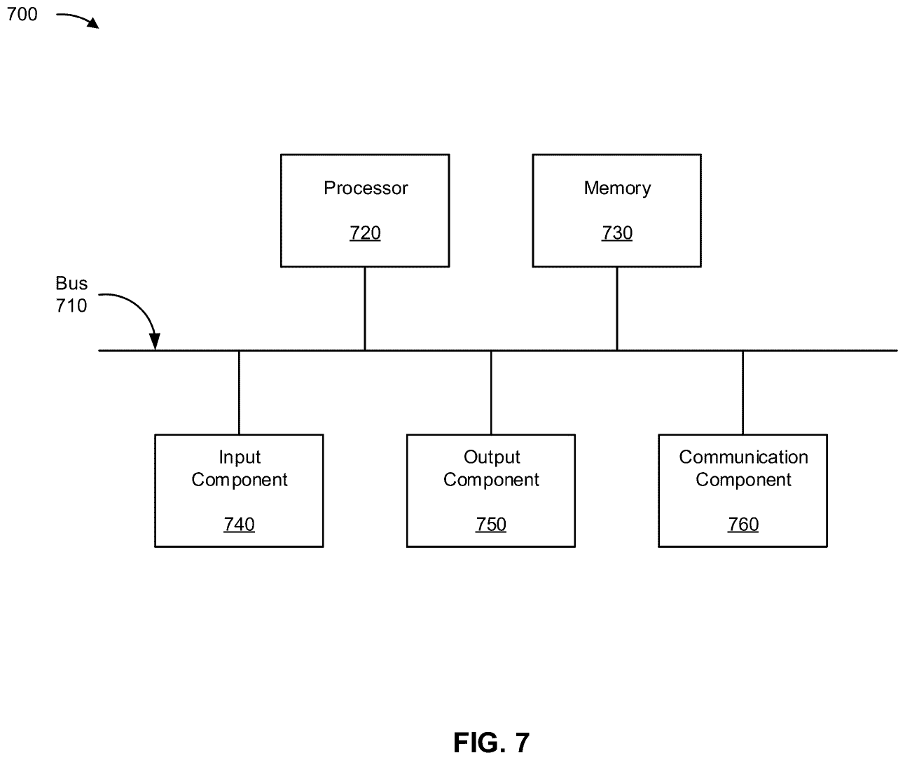

FIG. 7 is a diagram of example components of a device 700, which may correspond to the printer 610 and/or the user device 620. In some implementations, the printer 610 and/or the user device 620 may include one or more devices 700 and/or one or more components of device 700. As shown in FIG. 7, device 700 may include a bus 710, a processor 720, a memory 730, an input component 740, an output component 750, and a communication component 760.

Bus 710 includes one or more components that enable wired and/or wireless communication among the components of device 700. Bus 710 may couple together two or more components of FIG. 7, such as via operative coupling, communicative coupling, electronic coupling, and/or electric coupling. Processor 720 includes a central processing unit, a graphics processing unit, a microprocessor, a controller, a microcontroller, a digital signal processor, a field-programmable gate array, an application-specific integrated circuit, and/or another type of processing component. Processor 720 is implemented in hardware, firmware, or a combination of hardware and software. In some implementations, processor 720 includes one or more processors capable of being programmed to perform one or more operations or processes described elsewhere herein.

Memory 730 includes volatile and/or nonvolatile memory. For example, memory 730 may include random access memory (RAM), read only memory (ROM), a hard disk drive, and/or another type of memory (e.g., a flash memory, a magnetic memory, and/or an optical memory). Memory 730 may include internal memory (e.g., RAM, ROM, or a hard disk drive) and/or removable memory (e.g., removable via a universal serial bus connection). Memory 730 may be a non-transitory computer-readable medium. Memory 730 stores information, instructions, and/or software (e.g., one or more software applications) related to the operation of device 700. In some implementations, memory 730 includes one or more memories that are coupled to one or more processors (e.g., processor 720), such as via bus 710.

Input component 740 enables device 700 to receive input, such as user input and/or sensed input. For example, input component 740 may include a touch screen, a keyboard, a keypad, a mouse, a button, a microphone, a switch, a sensor, a global positioning system sensor, an accelerometer, a gyroscope, and/or an actuator. Output component 750 enables device 700 to provide output, such as via a display, a speaker, and/or a light-emitting diode. Communication component 760 enables device 700 to communicate with other devices via a wired connection and/or a wireless connection. For example, communication component 760 may include a receiver, a transmitter, a transceiver, a modem, a network interface card, and/or an antenna.

Device 700 may perform one or more operations or processes described herein. For example, a non-transitory computer-readable medium (e.g., memory 730) may store a set of instructions (e.g., one or more instructions or code) for execution by processor 720. Processor 720 may execute the set of instructions to perform one or more operations or processes described herein. In some implementations, execution of the set of instructions, by one or more processors 720, causes the one or more processors 720 and/or the device 700 to perform one or more operations or processes described herein. In some implementations, hardwired circuitry is used instead of or in combination with the instructions to perform one or more operations or processes described herein. Additionally, or alternatively, processor 720 may be configured to perform one or more operations or processes described herein. Thus, implementations described herein are not limited to any specific combination of hardware circuitry and software.

The number and arrangement of components shown in FIG. 7 are provided as an example. Device 700 may include additional components, fewer components, different components, or differently arranged components than those shown in FIG. 7. Additionally, or alternatively, a set of components (e.g., one or more components) of device 700 may perform one or more functions described as being performed by another set of components of device 700.

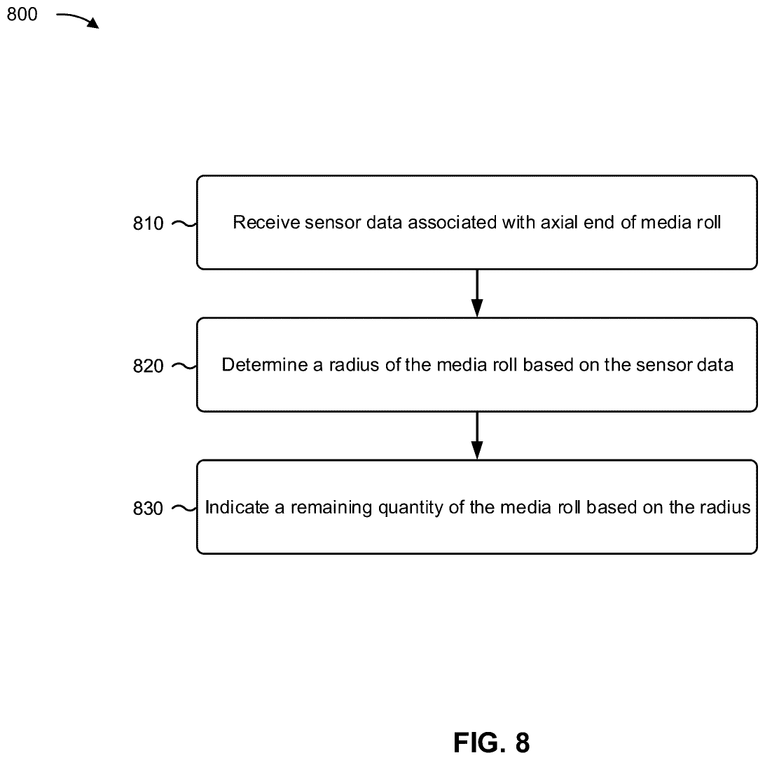

FIG. 8 is a flowchart of an example process 800 associated with managing one or more messages for a user account. In some implementations, one or more process blocks of FIG. 8 may be performed by an account management system (e.g., the printer 610). In some implementations, one or more process blocks of FIG. 8 may be performed by another device or a group of devices separate from or including the account management system, such as the user device 620. Additionally, or alternatively, one or more process blocks of FIG. 8 may be performed by one or more components of device 700, such as processor 720, memory 730, input component 740, output component 750, and/or communication component 760.

As shown in FIG. 8, process 800 may include receiving sensor data associated with an axial end of a media roll (block 810). For example, the printer 610 (and/or a controller of the printer 610) may receive the sensor data from an optical sensor and/or an image sensor as described elsewhere herein.

As further shown in FIG. 8, process 800 may include determining a radius of the media roll based on the sensor data (block 820). For example, the printer 610 may determine the radius based on processing an image of the axial end. Additionally, or alternatively, the printer may determine that the radius is greater than or equal to a threshold (e.g., a threshold that is based on a distance between an optical sensor that provided the sensor data and a support member holding the media roll).

As further shown in FIG. 8, process 800 may include indicating a remaining quantity of the media roll based on the radius (block 830). For example, the printer 610 may indicate a percentage of a maximum quantity of the media roll and/or whether the remaining quantity satisfies one or more thresholds (e.g., a low threshold, a medium threshold, a high threshold, and/or an adjustable threshold, among other examples).

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

Some implementations may be described herein to include a parallel relationship or a perpendicular relationship. As used herein, “parallel” corresponds to substantially parallel, such that parallel elements (e.g., parallel planes, parallel axes, and/or parallel surfaces associated with one or more items or features described herein) are considered or configured to be parallel according to a design tolerance, a manufacturing tolerance, and/or an industry standard. Similarly, as used herein, “perpendicular” corresponds to substantially perpendicular. Accordingly, perpendicular elements are considered or configured to be perpendicular according to a design tolerance, a manufacturing tolerance, and/or an industry standard.

As used herein, the term “component” is intended to be broadly construed as hardware, firmware, and/or a combination of hardware and software. As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, or the like) on which machine-readable instructions (e.g., code in the form of, for example, software and/or firmware) can be stored. The instructions may be stored for any suitable duration of time, such as permanently, for an extended period of time (e.g., while a program associated with the instructions is executing), or for a short period of time (e.g., while the instructions are cached, during a buffering process, or the like). Further, as used herein, each of the terms “tangible machine-readable medium,” “non-transitory machine-readable medium” and “machine-readable storage device” is expressly defined to exclude propagating signals. That is, as used in any claim herein, a “tangible machine-readable medium,” a “non-transitory machine-readable medium,” and a “machine-readable storage device,” or the like, should not be interpreted as being implemented as a propagating signal.

As used herein, satisfying a threshold may, depending on the context, refer to a value being greater than the threshold, greater than or equal to the threshold, less than the threshold, less than or equal to the threshold, equal to the threshold, not equal to the threshold, or the like.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system to monitor available media in a printer, comprising:
a media holder that includes:
a support frame, and
a support member that extends from the support frame,
wherein the support member is configured to receive a media roll; and
an optical sensor attached to the support frame of the media holder,
wherein the optical sensor is configured to include an axial end of the media roll within a field of view of the optical sensor, and
wherein the optical sensor is configured to output sensor data that indicates whether the media roll has available media according to a radius of the axial end.

2. The system of claim 1, wherein the support frame includes a track,
wherein the optical sensor is attached to the support frame via a housing of the optical sensor that is slidable within the track.

3. The system of claim 2, wherein a path of the track is perpendicular to a support axis of the support member, and
wherein the sensor data is indicative of a remaining quantity of the media roll based on a position of the optical sensor along the path.

4. The system of claim 1, wherein the optical sensor is a first optical sensor, the sensor data is first sensor data, and the field of view is a first line of sight of the first optical sensor, the system further comprising:
a second optical sensor attached to the support frame of the media holder,
wherein the second optical sensor is configured to have a second line of sight that is parallel to the first line of sight,
wherein a first distance between the first optical sensor and a support axis of the support member is different from a second distance that is between the second optical sensor and the support axis, and
wherein the first sensor data indicates whether the media roll has available media at the first distance and second sensor data from the second optical sensor indicates whether the media roll has available media at the second distance.

5. The system of claim 1, wherein the support member extends from the support frame along a support axis,
wherein the support axis is configured to be perpendicular to a plane of the axial end.

6. The system of claim 1, further comprising:
an output component; and
a controller that is configured to:
determine, based on the sensor data, the radius of the axial end; and
indicate, via the output component and based on the radius, the available media as a remaining quantity of the media roll.

7. The system of claim 6, wherein the optical sensor is an image sensor, and
wherein the sensor data is image data associated with a depiction of the axial end,
wherein the controller is configured to determine the radius based on processing the image data using an image processing technique.

8. The system of claim 6, wherein the optical sensor is a reflective sensor, and
wherein the sensor data is a binary indication of whether the media roll has available media at a radial distance along the radius of the axial end,
wherein the radial distance is based on an angular direction of the field of view and a distance between the optical sensor and the support member.

9. The system of claim 1, wherein the sensor data includes a binary indication of whether the media roll has available media at a radial distance along the radius that is based on a distance between the optical sensor and the support member.

10. The system of claim 1, wherein the optical sensor comprises:
a light emitter that is configured to emit light toward the axial end; and
a reflective sensor that is configured to generate the sensor data based on whether the optical sensor receives reflected light from the axial end of the media roll.

11. A printer, comprising:
a media holder that includes:
a support frame, and
a support member that extends from the support frame,
wherein the support member is configured to receive a media roll;
an optical sensor attached to the support frame of the media holder,
wherein the optical sensor is positioned to have a field of view that is directed toward an axial end of the media roll, and
wherein the optical sensor is configured to output sensor data that indicates whether the media roll has available media according to a radius of the axial end; and
a controller that is configured to:
determine, based on the sensor data, the radius of the axial end; and
indicate, via an output component and based on the radius, the available media as a remaining quantity of the media roll.

12. The printer of claim 11, wherein the support frame includes a track,
wherein the optical sensor is attached to the support frame via a housing of the optical sensor that is slidable within the track,
wherein a longitudinal axis of the path of the track is perpendicular to a support axis of the support frame,
wherein the controller indicates the remaining quantity based on the radius being greater than or equal to a distance between the support member and a position of the optical sensor along the path.

13. The printer of claim 11, wherein the support member extends from the support frame along a support axis,
wherein the support axis is configured to be perpendicular to a plane of the axial end.

14. The printer of claim 11, wherein the remaining quantity is indicated, via the output component of the printer, as at least one of:
a binary indication of whether the radius is greater than or equal to a distance between the support member and a position of the optical sensor,
one of a preconfigured set of ranges of remaining media, or
a percentage of a maximum quantity of the media roll that is based on a maximum radius of the media roll.

15. The printer of claim 11, wherein the optical sensor is an image sensor, and
wherein the sensor data is image data associated with a depiction of the axial end,
wherein the controller is configured to determine the radius based on processing the image data using an image processing technique.

16. The printer of claim 11, wherein the optical sensor is a reflective sensor, and
wherein the sensor data is a binary indication of whether the media roll has available media at a radial distance along the radius of the axial end,
wherein the radial distance is based on an angular direction of the field of view and a distance between the optical sensor and the support member.

17. The printer of claim 11, wherein the sensor data includes a binary indication of whether the media roll has available media at a radial distance along the radius that is based on a distance between the optical sensor and the support member.

18. The printer of claim 11, wherein the optical sensor comprises:
a light emitter that is configured to emit light toward the axial end; and
a reflective sensor that is configured to generate the sensor data based on whether the optical sensor receives reflected light from the axial end of the media roll.

19. A media holder for a printer comprising:
a support frame;
a support member that extends from the support frame,
wherein the support member is configured to receive a media roll; and
an optical sensor attached to the support frame of the media holder,
wherein the optical sensor is positioned to have a field of view that is directed toward an axial end of the media roll, and
wherein the optical sensor is configured to output sensor data that indicates, via an output component of the printer, whether the media roll has available media according to a radius of the axial end.

20. The media holder of claim 19, wherein the support frame includes a track,
wherein the optical sensor is attached to the support frame via a housing of the optical sensor that is slidable within the track,
wherein a longitudinal axis of a path of the track is perpendicular to a support axis of the support member.
